(19) United States
(12) Patent Application Publication
(10) Pub. No.: US 2026/0149070 A1
(43) Pub. Date: May 28, 2026

(54) THERMAL RUNAWAY DETECTION BY SENSORS

(71) Applicant: GM GLOBAL TECHNOLOGY OPERATIONS LLC, Detroit, MI (US)

(72) Inventors: Fang Wang, Troy, MI (US); Thomas Timpf, JR., Royal Oak, MI (US); Paul Ryan Campbell, Rochester, MI (US); Anthony P Tata, Linden, MI (US); Andrew C Baughman, Northville, MI (US)

(73) Assignee: GM GLOBAL TECHNOLOGY OPERATIONS LLC, Detroit, MI (US)

(21) Appl. No.: 18/957,792

(22) Filed: Nov. 24, 2024

(51) Int. Cl. H01M 10/48; B60L 58/12; B60L 58/24; H01M 10/42

(52) U.S. Cl. CPC H01M 10/482; B60L 58/12; H01M 10/425; H01M 10/486; B60L 58/24; H01M 2010/4278; H01M 2220/20

(57) ABSTRACT

Vehicles, systems and methods for using a sensor arrangement to evaluate an energy storage device are provided. A method includes arranging persistent sensor units and intermittent sensor units at nodes in the energy storage device wherein the persistent sensor units and the intermittent sensor units are electrically connected to be powered by respective nodes of the energy storage device; powering the persistent sensor units with the energy storage device; receiving persistent sensor readings from the persistent sensor units with a controller; selectively activating at least two of the intermittent sensor units while at least one of the intermittent sensor units is not activated; receiving intermittent sensor readings from the selectively activated intermittent sensor units with the controller; and evaluating, with the controller, the persistent sensor readings and the intermittent sensor readings to determine whether Thermal Runaway Propagation (TRP) conditions exist in the energy storage device.

### INTRODUCTION

The technical field generally relates to rechargeable energy storage systems (“RESS”) and more particularly relates to methods and sensor arrangements that may be used with an energy storage device such as a vehicle battery to detect thermal runaway conditions.

Rechargeable energy storage systems, including lithium-ion and related batteries, are increasingly being used in a variety of fields as a way to more efficiently generate, store, and distribute electrical power. In automotive applications, rechargeable energy storage systems are being used as a way to supplement, in the case of hybrid electric vehicles (HEVs), or supplant, in the case of purely electric vehicles (EVs), i.e., battery electric vehicles (BEVs), conventional internal combustion engines. The ability to passively store energy from stationary and portable sources, as well as from recaptured kinetic energy provided by the vehicle and its components, makes batteries ideal to serve as part of a propulsion system for cars, trucks, buses, motorcycles and related vehicular platforms. In the present context, a cell is a single electrochemical unit, whereas a battery is made up of one or more cells joined in series, parallel or both, depending on desired output voltage and capacity.

Battery electronics are oftentimes required to put in many hours of service in the field; sometimes, many more hours than is required of other electronic devices found in the vehicle. For example, a typical vehicle electronic module may see 8,000 hours of service over a 15 year period, while certain battery electronics may be required to put in 50,000 hours of service over the same amount of time. This type of increased demand can sometimes result in the battery electronics needing to be serviced or replaced at an accelerated rate.

Certain battery electronics, such as sensors for monitoring battery voltage, current, temperature, etc., may be packaged and mounted within the actual battery pack.

Accordingly, it is desirable to provide methods and systems for sensing conditions in a battery to diagnose thermal runaway conditions in a battery to provide for mitigation before excess heat causes thermal runaway. Furthermore, other desirable features and characteristics of the present disclosure will become apparent from the subsequent detailed description and the appended claims, taken in conjunction with the accompanying drawings and the foregoing introduction.

### SUMMARY

In embodiments herein, a method for using a sensor arrangement to evaluate an energy storage device is provided. The method includes arranging persistent sensor units and intermittent sensor units at nodes in the energy storage device wherein the persistent sensor units and the intermittent sensor units are electrically connected to be powered by respective nodes of the energy storage device; powering the persistent sensor units with the energy storage device; receiving persistent sensor readings from the persistent sensor units with a controller; selectively activating at least two of the intermittent sensor units while at least one of the intermittent sensor units is not activated; receiving intermittent sensor readings from the selectively activated intermittent sensor units with the controller; and evaluating, with the controller, the persistent sensor readings and the intermittent sensor readings to determine whether Thermal Runaway Propagation (TRP) conditions exist in the energy storage device.

In certain embodiments, the method further includes determining a state of charge (SOC) for each node; and identifying a node having a lowest SOC, wherein the at least one intermittent sensor unit that is not activated is electrically connected to the node having the lowest SOC.

In certain embodiments of the method, selectively activating at least two intermittent sensor units includes operating the at least two intermittent sensor units with a pulse width modulation (PWM) duty cycle.

In certain embodiments of the method, the persistent sensor units include temperature sensors and/or voltage sensors; and the intermittent sensor units include pressure sensors and/or gas sensors.

In certain embodiments of the method, the persistent sensor units include low power draw sensors; and the intermittent sensor units include high power draw sensors.

In certain embodiments of the method, during an off power mode, the controller receives persistent sensor readings; and during an on power mode, the controller receives persistent sensor readings and intermittent sensor readings.

In certain embodiments of the method, the intermittent sensor units include at least two types of the intermittent sensor units, the two types of the intermittent sensor units monitor different properties from one another, and the method further includes: reading and storing in the controller a map of the intermittent sensors; and storing in the controller a pulse width modulation (PWM) duty cycle for each type of intermittent sensor.

In certain embodiments, the method further includes identifying an unnecessary intermittent sensor based on a design of the energy storage device and based on operating conditions, such as when activating the controller, continuously, or routinely such as according to schedule.

In certain embodiments, the method further includes comparing node voltages across the energy storage device to determine two nodes qualified to power the at least two intermittent sensor units to enable sensor load optimization.

In certain embodiments, the method further includes setting the pulse width modulation (PWM) duty cycle for the at least two intermittent sensor units based on sensor type, current, and sampling rate.

In certain embodiments of the method, evaluating, with the controller, the persistent sensor readings and the intermittent sensor readings to determine whether thermal runaway conditions exist in the energy storage device includes evaluating persistent temperature readings, persistent node voltage readings, and intermittent pressure and/or gas readings.

In certain embodiments, the method further includes identifying conditions for entering an off power mode; and disabling the selectively activated at least two intermittent sensor units when entering the off power mode.

In certain embodiments, the method further includes, when thermal runaway conditions exist in the energy storage device, determining that a mitigation action is required to avoid thermal runaway.

In certain embodiments, the method further includes performing the mitigation action including alerting the user via horns and/or lights, or via a communication device such as aby email, text, or a phone call.

In certain embodiments, the method further includes performing the mitigation action including cooling the energy storage device and/or discharging the energy storage device.

In another embodiment, a battery monitoring system is provided and includes a high voltage rechargeable battery including cell stacks, wherein each cell stack includes battery cells; temperature sensors, wherein each temperature sensor is electrically connected to and powered by a respective cell stack, and wherein each temperature sensor monitors a temperature of the respective battery cell; intermittent sensors, wherein each intermittent sensor is electrically connected to and powered by a respective cell stack, and wherein each temperature sensor monitors the respective cell stack; and a controller operatively connected to the temperature sensors and to the intermittent sensors to receive readings therefrom, and configured to select intermittent sensors for activation and deactivation and to operate the intermittent sensors selected for activation.

In certain embodiments of the system, the controller is configured to select a respective pulse width modulation (PWM) duty cycle for each intermittent sensor and to operate each intermittent sensor selected for activation according to the respective pulse width modulation (PWM) duty cycle.

In certain embodiments of the system, the intermittent sensors include pressure sensors and/or gas sensors.

In another embodiment, a vehicle is provided and includes an electric motor configured to provide motive torque; and a battery system operatively connected to the electric motor and operable to provide electrical power to the electric motor, wherein the battery system includes: a high voltage rechargeable battery including cell stacks, wherein each cell stack includes battery cells; temperature sensors, wherein each temperature sensor is electrically connected to and powered by a respective battery cell, and wherein each temperature sensor monitors a temperature of the respective battery cell; intermittent sensors, wherein each intermittent sensor is electrically connected to and powered by a respective cell stack, and wherein each temperature sensor monitors the respective cell stack; and a controller operatively connected to the temperature sensors and to the intermittent sensors to receive readings therefrom, and configured to select intermittent sensors for activation and deactivation and to operate the intermittent sensors selected for activation.

In certain embodiments of the vehicle, the controller is configured to select a respective pulse width modulation (PWM) duty cycle for each intermittent sensor and to operate each intermittent sensor selected for activation according to the respective pulse width modulation (PWM) duty cycle.

In certain embodiments of the vehicle, the intermittent sensors include pressure sensors and/or gas sensors.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes an RESS and a control system for control thereof, among various other components, in accordance with exemplary implementations;

FIG. 2 is a schematic illustrated battery cells in cell groups in a portion of the RESS of FIG. 1;

FIG. 3 a schematic illustrating the operative connection between sensors, a power source or node, and a controller in accordance with exemplary implementations;

FIG. 4 is a graph illustrating operation of four same type high draw sensors in a battery system in accordance with exemplary implementations; and

FIG. 5 is a flowchart illustrating a method for controlling operation of sensors for monitoring for Thermal Runaway Propagation (TRP) conditions in a battery module in accordance with exemplary implementations.

### DETAILED DESCRIPTION

The following detailed description is merely exemplary in nature and is not intended to limit the disclosure or the application and uses thereof. Furthermore, there is no intention to be bound by any theory presented in the preceding introduction or summary or the following detailed description.

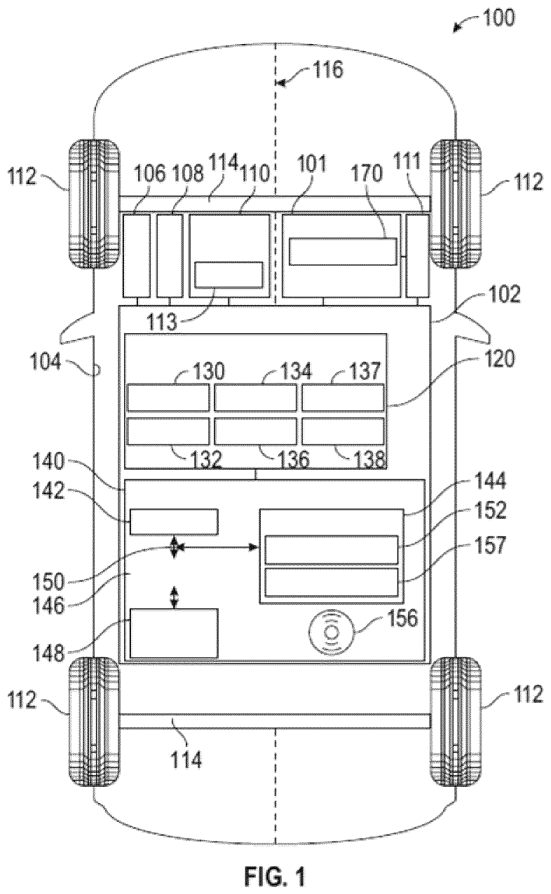

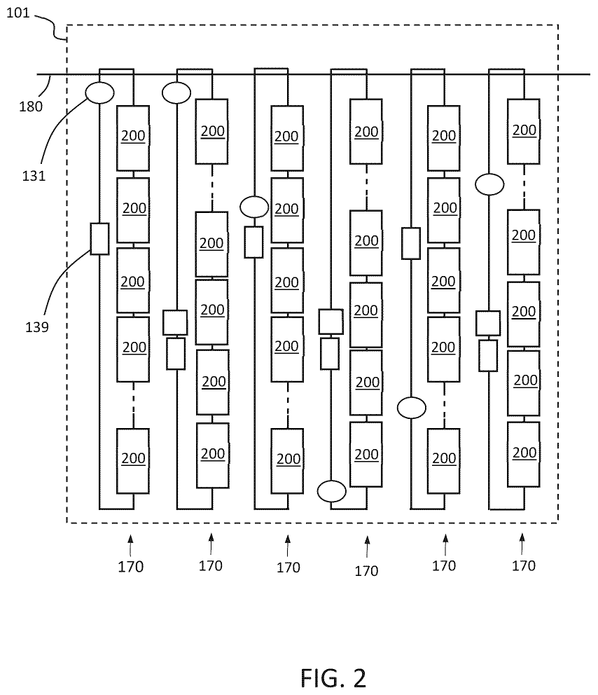

FIG. 1 illustrates a vehicle 100, according to an exemplary implementation. As described in greater detail further below, the vehicle 100 includes, among other components, a rechargeable energy storage system (“RESS”) 101 and a control system 102. In various implementations, the RESS 101 includes a plurality of cell groups 170, for example as depicted in FIG. 2 and described in greater detail further below in connection therewith. Also in various implementations, the control system 102 controls the RESS 101.

As depicted in FIG. 1, the RESS 101 and control system 102 are depicted as part of the vehicle 100 in accordance with exemplary implementations. In various implementations, the vehicle 100 comprises an automobile, such as any one of a number of different types of automobiles, such as, for example, a sedan, a wagon, a truck, sport utility vehicle (SUV), or the like. In certain implementations, the vehicle 100 may also comprise a motorcycle or other vehicle, such as aircraft, spacecraft, watercraft, and so on, and/or one or more other types of mobile platforms (e.g., a robot and/or another mobile platform). In yet other implementations, the RESS 101 and control system 102 may instead be part of and/or coupled to any number of other types of platforms and/or other systems, moving or non-moving, such as a building, infrastructure, secondary use, home power, non-automotive, and/or other platforms and/or other systems.

In the depicted implementation, the vehicle 100 includes a body 104 that is arranged on a chassis 116. The body 104 substantially encloses other components of the vehicle 100. The body 104 and the chassis 116 may jointly form a frame. The vehicle 100 also includes a plurality of wheels 112. The wheels 112 are each rotationally coupled to the chassis 116 near a respective corner of the body 104 to facilitate movement of the vehicle 100. In one implementation, the vehicle 100 includes four wheels 112, although this may vary in other implementations (for example for trucks, motorcycles, and certain other vehicles).

A drive system 110 is mounted on the chassis 116, and drives the wheels 112, for example via axles 114. In certain implementations, the drive system 110 comprises a propulsion system having an electric motor 113. In various implementations, the drive system 110, including the motor 113, receives high voltage from the RESS 101.

In various implementations, in addition to providing the high voltage to the motor 113, the RESS 101 also provides low voltage to one or more low voltage systems 111 of the vehicle 100. In various implementations, the low voltage systems 111 may include, by way of example, one or more climate control systems, radio systems, seat warming systems, and so on.

As depicted in FIG. 1, the vehicle also includes a braking system 106 and a steering system 108 in various implementations. In exemplary implementations, the braking system 106 controls braking of the vehicle 100 using braking components that are controlled via inputs provided by a driver (e.g., via a brake pedal) and/or automatically via a control system (such as the control system 102 and/or one or more other control systems). Also in exemplary implementations, the steering system 108 controls steering of the vehicle 100 via steering components that are controlled via inputs provided by a driver (e.g., via a steering wheel), and/or automatically via a control system (such as the control system 102 and/or one or more other control systems).

In the implementation depicted in FIG. 1, the control system 102 is coupled to the RESS 101, receives inputs therefrom, and controls functionality thereof. In addition, in certain implementations, the control system 102 is coupled to one or more of the braking system 106, steering system 108, drive system 110, and/or low voltage systems 111, and may also receive inputs from and/or control these additional systems in certain implementations.

Also as depicted in FIG. 1, in various implementations, the control system 102 includes a sensor array or arrangement 120 and a control module 140 (or controller), as described in greater detail below.

In various implementations, the sensor array 120 includes various sensors that obtain sensor data of the vehicle 100 for use in controlling, among other functionality, the RESS 101. In the depicted implementation, the sensor array 120 includes one or more voltage sensors 130, current sensors 132, temperature sensors 134, pressure sensors 136, gas sensors 137, and additional sensors 138.

In certain implementations, the voltage sensors 130 measure voltage of the RESS 101, including of the various cell groups 170 thereof. Also in certain implementations, the current sensors 132 measure electric current of the RESS 101, including of battery cells 200 (shown in FIG. 2) or of the cell groups 170 thereof. In various implementations, the temperature sensors 134 measure temperature of the RESS 101, including of battery cells 200 (shown in FIG. 2) or of the cell groups 170 thereof.

Also in various implementations, the pressure sensors 136 measure the pressure within a battery cell 200 (shown in FIG. 2) or within a cell group 170 of the RESS 101. In addition, various implementations, the gas sensors 137 monitor, identify, and/or measure what gas or gases are present within a battery cell 200 (shown in FIG. 2) or within a cell group 170 of the RESS 101. Further, additional sensors 138 may monitor or measure one or more other parameters pertaining to conditions within a battery cell 200 (shown in FIG. 2) or within a cell group 170 of the RESS 101.

It is noted that the sensors 130, 132, 134, 136, 137, and/or 138 may be considered to be “low draw” or “low load” or “high draw” or “high load” sensors. Specifically, a sensor that draws or uses a low amount of electricity, such as ______, may be considered to be a low draw or low load sensor, while a sensor that draws or uses a high amount of electricity, such as ______, may be considered to be a high draw or high load sensor. In embodiments herein, sensors 130, 132, and 134 may be low draw sensors, and sensors 134, 136, and 137 may be high draw sensors.

In various implementations, the control module 140 is coupled to the sensor array 120 and receives sensor data therefrom. In various implementations, the control module 140 is further coupled to the RESS 101. In addition, in certain implementations, the control module 140 may also be coupled to one or more other systems of the vehicle 100, such as the braking system 106, steering system 108, drive system 110, and/or low voltage systems, for example for receiving input thereof and/or for controlling thereof.

As depicted in FIG. 1, in various implementations, the control module 140 comprises a computer system, and includes a processor 142, a memory 144, an interface 146, a storage device 148, and a computer bus 150.

The processor 142 performs the computation and control functions of the control module 140, and may comprise any type of processor or multiple processors, single integrated circuits such as a microprocessor, or any suitable number of integrated circuit devices and/or circuit boards working in cooperation to accomplish the functions of a processing unit. During operation, the processor 142 executes one or more programs 152 contained within the memory 144 and, as such, controls the general operation of the control module 140 and the computer system of the control module 140, generally in executing the processes described herein.

The memory 144 can be any type of suitable memory, including various types of non-transitory computer readable storage medium. In certain examples, the memory 144 is located on and/or co-located on the same computer chip as the processor 142. In the depicted implementation, the memory 144 stores the above-referenced program 152 along with stored values 157 (e.g., look-up tables, thresholds, and/or other values with respect to control of the RESS 101).

The interface 146 allows communication to the computer system of the control module 140, for example from a system driver and/or another computer system, and can be implemented using any suitable method and apparatus. In one implementation, the interface 146 obtains the various data from the sensor array 120, among other possible data sources. The interface 146 can include one or more network interfaces to communicate with other systems or components. The interface 146 may also include one or more network interfaces to communicate with technicians, and/or one or more storage interfaces to connect to storage apparatuses, such as the storage device 148.

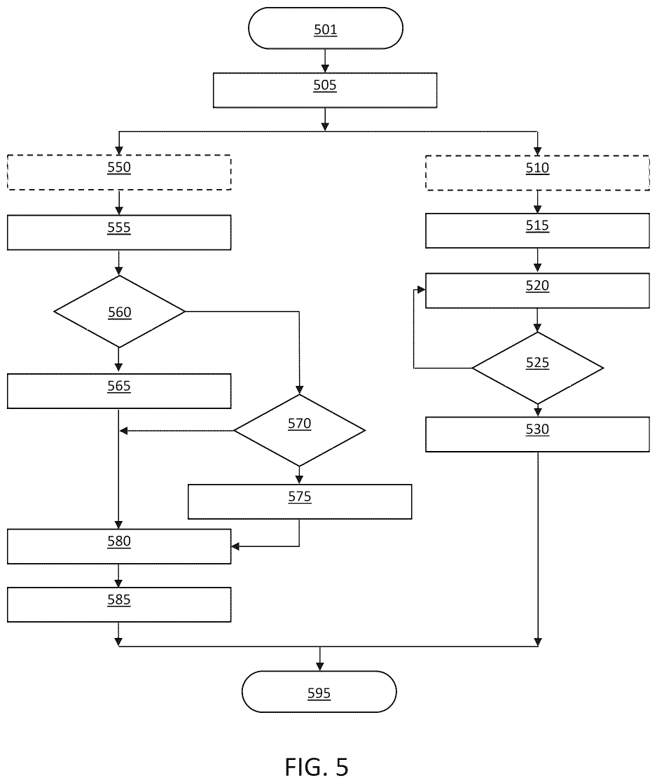

The storage device 148 can be any suitable type of storage apparatus, including various different types of direct access storage and/or other memory devices. In one exemplary implementation, the storage device 148 comprises a program product from which memory 144 can receive a program 152 that executes one or more implementations of one or more processes of the present disclosure, such as the steps of the method 500 of FIG. 5 and described further below in connection therewith. In another exemplary implementation, the program product may be directly stored in and/or otherwise accessed by the memory 144 and/or a disk (e.g., disk 156), such as that referenced below.

The bus 150 serves to transmit programs, data, status and other information or signals between the various components of the computer system of the control module 140. The bus 150 can be any suitable physical or logical means of connecting computer systems and components. This includes, but is not limited to, direct hard-wired connections, fiber optics, infrared and wireless bus technologies. During operation, the program 152 is stored in the memory 144 and executed by the processor 142.

It will be appreciated that while this exemplary implementation is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 142) to perform and execute the program.

FIG. 2 is a functional diagram of a portion of the RESS 101 of FIG. 1, such as a battery module 101. As shown, the battery module includes a plurality of cell groups 170, in accordance with exemplary implementations.

As depicted in FIG. 2, in various implementations, the battery module 101 includes a number of cell groups 170. In certain embodiments, the cell groups 170 are connected in series via bus bar 180. The cells group may be configured electrically in series as shown and/or in parallel. It will be appreciated that the number and configuration of cell groups 170 may vary in different implementations, and the subject matter described herein is not limited to any particular number, type or configuration of cell groups 170. The bus bar 180 may be connected to the drive system 110.

In certain embodiments, each cell group 170 may include one or more battery cells 200 or other energy storage elements. As shown the battery cells 200 may be arranged in a stack, such that the cell groups 170 are referred to as cell stacks 170. The battery cells 200 may be configured electrically in series or in parallel to provide a desired DC voltage level and/or DC output current. While each cell group 170 is illustrated as including five battery cells 200, the number of battery cells 200 per cell group 170 may be any desired suitable number.

As shown in FIG. 2, low draw sensors 131 are located at desired locations in the battery module 101. As explained above, the low draw sensors 131 may include one or more voltage sensors 130, one or more current sensors 132, and/or one or more temperature sensors 134.

As further shown in FIG. 2, high draw sensors 139 are located at desired locations in the battery module 101. As explained above, the high draw sensors 139 may include one or more pressure sensors 136, one or more gas sensors 137, and/or one or more additional sensors 138.

In certain embodiments, each of sensors 131 and 139 is dedicated to a respective battery cell 200 or to a respective cell group 170. Thus, each of sensors 131 and 139 may monitor and/or measure a condition or conditions at the respective battery cell 200 or cell group 170. Further, each of sensors 131 and 139 may be powered by the respective battery cell 200 or cell group 170. In other words, in certain embodiments, a respective sensor is powered by and monitors a same battery cell 200 or cell group 170, i.e., a same node. As used herein a “node” may be an individual battery cell 200 or a collection or plurality of battery cells 200, such as a cell group 170, or in certain embodiments, a collection of cell groups 170.

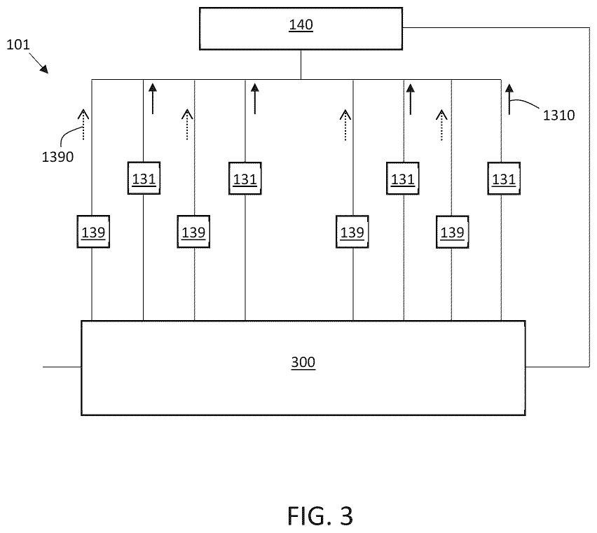

FIG. 3 further illustrates embodiments of sensor array or arrangement 120 including sensors 131 and 139 and a node 300 in the battery module 101. While FIG. 3 illustrates a single node 300 and associated sensors 131 and 139, the battery module 101 may include a plurality of nodes 300 and associated sensors 131 and 139.

As shown in FIG. 3, each of sensors 131 and 139 are operatively connected to node 300. Thus, the node 300 may power operation of each of the sensors 131 and 139. Further, each of the sensors 131 and 139 are located at a desired location to monitor or measure a condition, state, or property of the node 300. As further shown, each of the sensors 131 and 139 is connected to the control module 140. The control module 140 is configured to receive a signal or reading from each sensor 131 and 139, when activated, indicative of the monitored condition, state or property of node 300. Further, with the operative connection between each respective sensor 131 and 139 and the control module 140, the control module 140 may enable (or activate) and disable (or de-activate) each respective sensor 131 or 139 as desired.

In embodiments herein, it may be desirable to disable a high draw sensor 139 so that the specific node 300 powering the high draw sensor 139, and the battery module 101 in general, does not drop to a low state of charge (SOC). In such embodiments, a low draw sensor 131 or low draw sensors 131 may remain enabled and in operation continuously. Thus, each low draw sensor 131 may provide a persistent signal or reading 1310 to the control module 140. Further, each high draw sensor 139 may provide an intermittent signal or reading 1390 to the control module 140. Specifically, each high draw sensor 139 may provide a signal or reading 1390 to the control module 140 when enable or activated. When disabled or deactivated, the specific high draw sensor 139 is not operable, does not monitor or measure a condition of the node 300, and does not provide a signal or reading to the control module 140.

Further, the sensor arrangement 120 provides for non-continuous, i.e., intermittent operation of a selected high draw sensor 139, even when enabled or activated. For example, the control module 140 may determine a pulse width modulation (PWM) duty cycle for each specific or selected high draw sensor 139 based on the sensor type, i.e., pressure sensor 136, gas sensor 137, or additional sensor 138, based on current, and/or based on sampling rate. Then, the control module 140 may operate the specific or selected high draw sensor 139 according to the pulse width modulation (PWM) duty cycle, providing the intermittent signal 1310 according to the duty cycle. In this manner, the total energy used by the specific or selected high draw sensor 139, when enabled or activated, is less than when powered continuously during periods of being enabled or activated.

Certain embodiments herein further provide for reduced power consumption by the sensor array or arrangement 120 by selective activating only two high load sensors 139 for any given node 300. For example, a cell group 170 may be provided with three or more different high load sensors 139 of a same or single type, i.e., three or more pressure sensors, three or more gas sensors, or three or more additional sensors. Each of the same-type high load sensors 139 may be operatively powered by different battery cells 200 within the cell group 170.

In order to reduce power consumption, and to balance loads across battery cells 200 within the cell group 170, the control module 140 may determine which battery cell or cells 200 having a same-type high load sensor 139 has the lowest state of charge (SOC). Further, the control module 140 may determine which battery cell or cells 200 having a same-type high load sensor 139 has the highest state of charge (SOC). The control module 140 may enable or activate only two of the same-type high load sensors 139 while disenabling or de-activating the remaining same-type high load sensor 139. In certain embodiments, the control module 140 ensures that the same-type high load sensors 139 having the lowest state of charge (SOC) are not enabled. In certain embodiments, the control module 140 ensures that the same-type high load sensors 139 having the highest state of charge (SOC) are enabled. In this manner, the load of the sensors 139 is balanced across the battery cells 200 within the cell group 170.

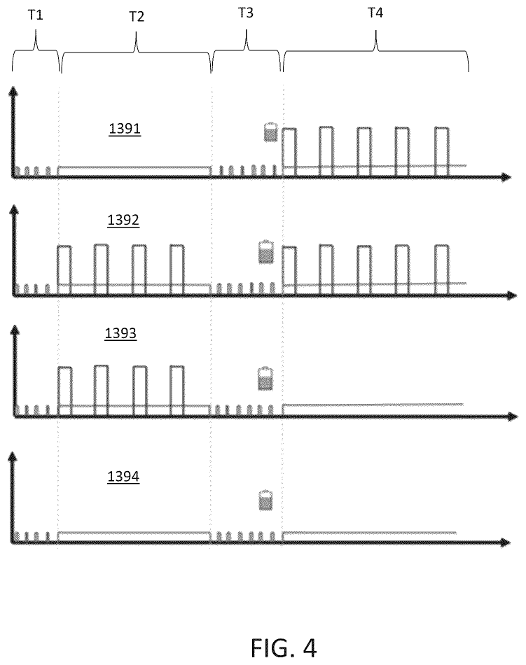

FIG. 4 illustrates the pulse width modulation duty cycles for four same-type high load sensors 1391, 1392, 1393, and 1394, wherein time is shown on the X-axis and power is shown on the Y-axis.

As shown, none of the four same-type high load sensors 1391, 1392, 1393, and 1394 is enabled during an initial period of time T1. For example, time period T1 may be when the vehicle is in an OFF power mode, i.e., not using power, either for driving or for re-charging.

Before or at time period T2, the control module 140 has identified same-type high load sensors 1392 and 1393 as having a higher or highest state of charge (SOC) and has identified same-type high load sensors 1391 and 1394 as having a lower or lowest state of charge (SOC). Therefore, at time period T2, control module 140 enables or activates same-type high load sensors 1392 and 1393 while same-type high load sensors 1391 and 1394 remain disabled or de-activated. Further, as shown in FIG. 4, the control module 140 operates the same-type high load sensors 1392 and 1393 according to a pulse width modulation (PWM) duty cycle. While FIG. 4 illustrates a same pulse width modulation (PWM) duty cycle for same-type high load sensors 1392 and 1393 during time period T2, the pulse width modulation (PWM) duty cycles may differ. Time period T2 may be when the vehicle is in a normal operating mode, i.e., an ON power mode such as while driving and/or while charging.

As shown, none of the four same-type high load sensors 1391, 1392, 1393, and 1394 is enabled during a period of time T3. For example, time period T3 may be when the vehicle is in an OFF power mode, i.e., not using power, either for driving or for re-charging.

Before or at time period T4, the control module 140 has identified same-type high load sensors 1391 and 1392 as having a higher or highest state of charge (SOC) and has identified same-type high load sensors 1393 and 1394 as having a lower or lowest state of charge (SOC). Therefore, at time period T2, control module 140 enables or activates same-type high load sensors 1391 and 1392 while same-type high load sensors 1393 and 1394 remain disabled or de-activated. Further, as shown in FIG. 4, the control module 140 operates the same-type high load sensors 1391 and 1392 according to a pulse width modulation (PWM) duty cycle. While FIG. 4 illustrates a same pulse width modulation (PWM) duty cycle for same-type high load sensors 1391 and 1392 during time period T4, the pulse width modulation (PWM) duty cycles may differ. Time period T4 may be when the vehicle is in a normal operating mode, i.e., an ON power mode such as while driving and/or while charging.

Embodiments herein may be used to monitor for Thermal Runaway Propagation (TRP) conditions in a battery module. Thermal Runaway Propagation (TRP) occurs when a cell reaches its thermal runaway triggering temperature, which causes additional exothermic reactions to occur. These reactions release uncontrollable heat, which can lead to thermal runaway. Thermal runaway propagation (TRP) conditions may include propagation probability, for example, the probability of TRP may be highest when the state of charge (SOC) is between 40% and 60%; propagation direction within the module; propagation speed, for example, physical barriers can slow the speed of TRP; propagation intensity, generally the intensity of TRP increases as more battery cells experience thermal runaway; propagation effects, TRP may cause intense combustion, high-speed flame jets, and explosions; airflow rate, TRP behaviors may differ depending on the airflow rate - for example a low flow rate may suppress fire due to limited oxygen, while a higher flow rate may aggravate TRP; gas diffusion may accelerate the velocity of TRP. Therefore, temperatures in the battery module or at specific battery cells may indicate TRP conditions, pressures in the battery module or at specific battery cells may indicate TRP conditions, the presence of certain gases, such as gases forming during combustion, in the battery module or at specific battery cells may indicate TRP conditions, as well as other properties or characteristics.

FIG. 5 is a flow chart illustrating a method 500 for operating a RESS or battery module 101. As shown, the method 500 may begin at start operation 501. Method 500 includes, at operation 505, reading and storing a TRP sensor map for each ASIC in the host controller. At operation 510, method 500 may continue in a mode in which the host controller is put in sleep mode. At operation 515, method 500 disables the power outputs to all high load TRP sensors. At operation 520, method 500 includes continuously monitoring TRP through cell voltage and distributed temperatures.

At query 525, method 500 determines whether there are any anomalies in cell voltage, temperature, or COM. When no anomalies are present, method 500 continues with continuously monitoring TRP through cell voltage and distributed temperatures at operation 520. When there is an anomaly, then at operation 530, method 500 wakes the host controller to determine whether any necessary mitigation action is required. When necessary mitigation action is required, then, at operation 595, method 500 may end with performing the mitigation action, such as cooling the battery module or discharging the battery module or selected battery cells or cell groups therein.

At operation 550, method 500 performs functions when turning on the host controller. For example, at operation 555, method 500 includes refining the sensor pulse width modulation (PWM) duty cycle per pack, cell voltage, and cell stack conditions.

At query 560, method 500 determines whether there are more than two of the same type high load sensors. When there are more than two of the same type high load sensors, then at operation 580, method 500 compares the cell voltages across the pack to select two sensors to be powered, while leaving the other sensors un-powered. When there are not more than two of the same type high load sensors, then at operation 580, then at query 570, method 500 determines whether any specific TRP high load sensor type should be disabled. For example, pressure sensor or gas sensors may be disabled. When a specific TRP high load sensor type should be disabled, then, at operation 575, the method disables all sensors of the specific TRP high load sensor type.

As shown, method 500 continues at operation 580 with using the cell voltage and temperature signals from low draw sensors and the signals from high draw sensors to perform TRP monitoring at normal battery operating mode.

Method 500 may perform a closed loop cycling under operation 550 to refine the sampling rate for each specific high load sensor.

It will be appreciated that the systems, vehicles, and methods may vary from those depicted in the Figures and described herein. It will similarly be appreciated that the steps of the methods may differ from that depicted in the Figures, and/or that various steps of the methods may occur concurrently and/or in a different order than that depicted and/or described above in connection therewith.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for using a sensor arrangement to evaluate an energy storage device, comprising the steps of:
arranging persistent sensor units and intermittent sensor units at nodes in the energy storage device wherein the persistent sensor units and the intermittent sensor units are electrically connected to be powered by respective nodes of the energy storage device;
powering the persistent sensor units with the energy storage device;
receiving persistent sensor readings from the persistent sensor units with a controller;
selectively activating at least two of the intermittent sensor units while at least one of the intermittent sensor units is not activated;
receiving intermittent sensor readings from the selectively activated intermittent sensor units with the controller; and
evaluating, with the controller, the persistent sensor readings and the intermittent sensor readings to determine whether Thermal Runaway Propagation (TRP) conditions exist in the energy storage device.

2. The method of claim 1, further comprising:
determining a state of charge (SOC) for each node; and
identifying a node having a lowest SOC, wherein the at least one intermittent sensor unit that is not activated is electrically connected to the node having the lowest SOC.

3. The method of claim 1, wherein selectively activating at least two intermittent sensor units comprises operating the at least two intermittent sensor units with a pulse width modulation (PWM) duty cycle.

4. The method of claim 1, wherein:
the persistent sensor units comprise temperature sensors and/or voltage sensors; and
the intermittent sensor units comprise pressure sensors and/or gas sensors.

5. The method of claim 1, wherein:
the persistent sensor units comprise low power draw sensors; and
the intermittent sensor units comprise high power draw sensors.

6. The method of claim 1, wherein:
during an off power mode, the controller receives persistent sensor readings; and
during an on power mode, the controller receives persistent sensor readings and intermittent sensor readings.

7. The method of claim 1, wherein the intermittent sensor units include at least two types of the intermittent sensor units, wherein the two types of the intermittent sensor units monitor different properties from one another, and wherein the method further comprises:
reading and storing in the controller a map of the intermittent sensors; and
storing in the controller a pulse width modulation (PWM) duty cycle for each type of intermittent sensor.

8. The method of claim 7, further comprising:
identifying an unnecessary intermittent sensor based on a design of the energy storage device and based on operating conditions.

9. The method of claim 8, further comprising:
comparing node voltages across the energy storage device to determine two nodes qualified to power the at least two intermittent sensor units to enable sensor load optimization.

10. The method of claim 9, further comprising:
setting the pulse width modulation (PWM) duty cycle for the at least two intermittent sensor units based on sensor type, current, and sampling rate.

11. The method of claim 10, wherein evaluating, with the controller, the persistent sensor readings and the intermittent sensor readings to determine whether thermal runaway conditions exist in the energy storage device comprises evaluating persistent temperature readings, persistent node voltage readings, and intermittent pressure and/or gas readings.

12. The method of claim 11, further comprising:
identifying conditions for entering an off power mode; and
disabling the selectively activated at least two intermittent sensor units when entering the off power mode.

13. The method of claim 12, further comprising:
when thermal runaway conditions exist in the energy storage device, determining that a mitigation action is required to avoid thermal runaway.

14. The method of claim 13, further comprising performing the mitigation action including cooling the energy storage device and/or discharging the energy storage device or by communicating an alert via a horn, light, or communication device.

15. A battery monitoring system comprising:
a high voltage rechargeable battery including cell stacks, wherein each cell stack comprises battery cells;
temperature sensors, wherein each temperature sensor is electrically connected to and powered by a respective cell stack, and wherein each temperature sensor monitors a temperature of the respective battery cell;
intermittent sensors, wherein each intermittent sensor is electrically connected to and powered by a respective cell stack, and wherein each temperature sensor monitors the respective cell stack; and
a controller operatively connected to the temperature sensors and to the intermittent sensors to receive readings therefrom, and configured to select intermittent sensors for activation and deactivation and to operate the intermittent sensors selected for activation.

16. The battery monitoring system of claim 15, wherein the controller is configured to select a respective pulse width modulation (PWM) duty cycle for each intermittent sensor and to operate each intermittent sensor selected for activation according to the respective pulse width modulation (PWM) duty cycle.

17. The battery monitoring system of claim 16, wherein the intermittent sensors comprise pressure sensors and/or gas sensors.

18. A vehicle comprising:
an electric motor configured to provide motive torque; and
a battery system operatively connected to the electric motor and operable to provide electrical power to the electric motor, wherein the battery system comprises:
a high voltage rechargeable battery including cell stacks, wherein each cell stack comprises battery cells;
temperature sensors, wherein each temperature sensor is electrically connected to and powered by a respective battery cell, and wherein each temperature sensor monitors a temperature of the respective battery cell;
intermittent sensors, wherein each intermittent sensor is electrically connected to and powered by a respective cell stack, and wherein each temperature sensor monitors the respective cell stack; and
a controller operatively connected to the temperature sensors and to the intermittent sensors to receive readings therefrom, and configured to select intermittent sensors for activation and deactivation and to operate the intermittent sensors selected for activation.

19. The vehicle of claim 18, wherein the controller is configured to select a respective pulse width modulation (PWM) duty cycle for each intermittent sensor and to operate each intermittent sensor selected for activation according to the respective pulse width modulation (PWM) duty cycle.

20. The vehicle of claim 19, wherein the intermittent sensors comprise pressure sensors and/or gas sensors.
